(19) United States
(12) Patent Application Publication
(10) Pub. No.: US 2008/0254695 A1
(43) Pub. Date: Oct. 16, 2008

(54) Liquid Textile-Pretreating Agent

(76) Inventor: Manfred Jungen, Lauwil (CH)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/593,169

(22) PCT Filed: Mar. 2, 2005
(86) PCT No.: PCT/IB2005/000569

§ 371 Date: Sep. 15, 2006

(30) Foreign Application Priority Data
Mar. 17, 2004 (EP) 04006338.0

(51) Int. Cl. D06M 13/288; C07F 9/141; B32B 3/00

(52) U.S. Cl. 442/59; 558/177; 558/104; 252/8.61

(57) ABSTRACT

The present invention concerns a liquid textile-pretreating agent useful in all continuous and batch pretreatment operations which is based on phosphoric esters of alkoxylated Guerbet alcohols and is very stable to alkali not only in the formulation but also in the liquor. It is usually used in the form of an aqueous composition having an active content in the range from 40% to 70% by weight, with or without 0.1% to 3.5% by weight of further auxiliary materials, examples being surfactants, biocides, defoamers or foam suppressants.

The present invention concerns a liquid textile-pretreating agent useful in all continuous and batch pretreatment operations which is based on phosphoric esters of alkoxylated Guerbet alcohols and is very stable to alkali not only in the formulation but also in the liquor.

In grey cloth conversion, the pretreatment of the natural or synthetic fibre materials constitutes an important basis for the further processing. The various operations such as desizing, scouring, bleaching or mercerizing employ a wide range of textile chemicals, examples being surfactants, dispersants, emulsifiers, bleaches, foam suppressants or defoamers. Among the requirements which these auxiliaries as they are known have to meet is high stability to alkali, especially in the alkaline scouring of woven cotton fabric. There is accordingly a constant need for new active compounds having a suitable performance profile.

It has now been found that, surprisingly, phosphoric esters of specific alkoxylated Guerbet alcohols are very useful for continuous and batch pretreatment of textile material. Alkoxylated Guerbet alcohols as such are known for example from WO 03/091192 A1. Although the use in formulations for the textile industry is disclosed there, no pointer is given to the excellent and surprising properties of the phosphoric esters.

The invention accordingly provides compounds of the formula (I)

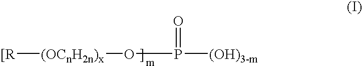

where
m is from 1 to 3,
n is from 2 to 4,
x is from 4 to 12, and
R is a radical of the formula (II)

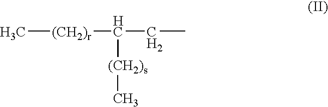

where
r is from 0 to 8,
s is from 0 to 8,
the sum total of (r+s) is from 4 to 8, and
the alkyl chains may in turn be linear or branched.

The present compounds are highly stable surfactants which can be present as a highly concentrated, for example 60% solution in water without any need for additives. This combines with good wettability and low foam-forming tendency into a unique performance profile. Especially the extremely high stability to alkali not only in the formulation but also in the liquor predestines these compounds for the alkaline scour, but use as a dispersant, as an emulsifier or as a defoamer component is also possible.

Also of very high suitability are compounds wherein
m is from 1 to 3,
n is 2 or 3,
x is from 6 to 8,
r is from 2 to 6,
s is from 0 to 4, and
the sum total of (r+s) is from 5 to 7.

Especially good properties are exhibited by compounds wherein
m is from 1 to 2,
n is 2,
x is 7,
r is 4,
s is 2, and
the sum total of (r+s) is 6.

The index m is an average value, and a particularly preferred value for m is from 1.2 to 1.3.

The present compounds are prepared by alkoxylation of appropriate Guerbet alcohols as described in WO 03/091192 A1 and subsequent phosphation, preferably with phosphorus pentoxide. The alkylene oxide units of the Guerbet alcohols used are mostly ethylene oxide or propylene oxide units, but mainly ethylene oxide units combined with low fractions of propylene oxide or else only ethylene oxide units. Phosphation is effected by portionwise addition of the phosphating agent at 90 to 120° C. during 4 to 24 hours in the absence of air.

The present compounds can be used as such or in the form of an aqueous composition for pretreating textiles.

The present invention thus further provides a composition comprising an aqueous solution of one or more compounds of the formula (I) and also further auxiliaries.

Preferably, the aqueous composition comprises 40% to 70% by weight of compound (I), although about 2% to 4% by weight can also be present in the form of the sodium salts. The composition may further comprise 0.1% to 3.5% by weight of further auxiliary materials, examples being surfactants, biocides, defoamers or foam suppressants.

The composition according to the invention is obtainable by simply mixing its constituents.

A preferred use of compounds of the formula (I) or of the abovementioned aqueous composition is the pretreatment of textiles in continuous or batch operations under alkaline conditions.

The examples which follow illustrate the invention.

### EXAMPLES

There now follows a description of the alkoxylated Guerbet alcohols used, of the products obtained therefrom by phosphation, the aqueous formulations produced therefrom and the resulting applicatory results in table form.

The following test methods were employed:

Alkali Stability
What is tested is the alkali stability of 5 g/l of surfactant, with 100 ml of liquor being made up in each case. The test takes place at room temperature 20 to 25° C. The required amount of aqueous sodium hydroxide solution is weighed into a glass beaker and made up to 95 ml with demineralized water. 5 ml of a 10% surfactant solution are added to the alkali batches with stirring. The glass beakers are left to stand at room temperature for 24 hours without stirring.
The solutions are tested for their stability after 24 hours. Creaming and precipitates are to be noted in particular, cloudiness without visible deposits being permissible. What is to be ascertained is the concentration at which the surfactant is still stable. Alkali stability is reported in X of °Bé- NaOH.

Ross-Miles Foam Test
The foam volume is measured after a certain amount of liquid has been poured from a certain height, instantly and after a one minute wait.
A 1000 ml graduated cylinder 60 mm in internal diameter and 430 mm in internal height is used. The test liquid is allowed to pour out from a 2 l separating funnel through a capillary 70 mm in length and 2 mm in internal diameter from a height of 600 mm, measured from the outlet of the capillary above the floor of the cylinder.
500 ml of the solution to be tested are filled into the separating funnel and allowed to flow out into the graduated cylinder through the capillary-controlled efflux rate of about 0.17 l/min. As soon as the entire solution has flowed out, a stopwatch is started and the entire volume (foam volume plus solution volume) is read off the cylinder scale. The reading is repeated after one minute.
The alkaline foam performance is tested using a surfactant concentration of 2 g/l in 2° Bé NaOH solution in demineralized water, with 2° Bé NaOH being equivalent to 12 g/l of NaOH solid or 30 ml/l of NaOH 36° Bé. The test temperature is 20 to 25° C.

Alkaline Wetting
This test method determines the number of seconds a fabric sample takes to sink to the bottom of a glass beaker 111 in content, 14 cm in height and 10 cm in diameter in a surfactant solution. The fabric sample used is a cotton test cloth, from EMPA Testmaterialien AG of St. Gallen, Switzerland. Circularly round discs 3.5 cm in diameter are die cut out of this cloth and dipped with a special holder into the surfactant solution. The wetting action is tested in 2° Bé NaOH at 25° C.

TABLE 1
Utilized alkoxylated Guerbet alcohols and other alcohols

| | | | | Residual |
|---|---|---|---|---|
| No. | Alcohol | EO | PO | alcohol |
| 1 | not less than 70% of 2-propyl-1-heptanol, | 7 | 0 | 6 |
| | not more than 30% of 2-propylisoheptanol | | | |
| 2 | not less than 70% of 2-propyl-1-heptanol, | 10 | 0 | 2 |
| | not more than 30% of 2-propylisoheptanol | | | |
| 3 | not less than 70% of 2-propyl-1-heptanol, | 7 | 1 | <=1 |
| | not more than 30% of 2-propylisoheptanol | | | |
| V1 | i-Undecanol (Standard) | 7 | 0 | low |
| V2 | Exxal-C11 (i-C11 from Exxon) | 7 | 0 | low |
| V3 | i-C12/C14 | 7 | 0 | low |

EO, PO=ethylene oxide, propylene oxide; V1 to V3 are comparative alcohols.

TABLE 2
Phosphation

| | | ¼ P4O10 | Temperature | No. |
|---|---|---|---|---|
| Alcohol | Molar | Molar | Phosphation | phos- |
| No. | ratio | ratio | in ° C. | phate |
| 1 | 1 | 1.25 | 6 h 100° C. | I |
| 1 | 1 | 1.25 | 24 h 115° C. | II |
| 2 | 1 | 1.25 | 6 h 100° C. | III |
| 3 | 1 | 1.25 | 6 h 100° C. | IV |
| 3a | 0.9 of alcohol 3 + | 1.25 | 6 h 100° C. | V |
| | 0.1 of isodecanol | | | |

COMPARATIVE TESTS

| | | | | |
|---|---|---|---|---|
| V1 | 1 | 1.25 | 6 h 100° C. | VI |
| V2 | 1 | 1.25 | 6 h 100° C. | VII |
| V3 | 1 | 1.25 | 6 h 100° C. | VIII |

TABLE 3
Aqueous formulations

| Formu- | | | Concentration | |
|---|---|---|---|---|
| lation | Sub- | Components | in % by | |
| No. | number | Designation | weight | Comment |
| I | a | Phosphate I | 60.00% | problem-free |
| | | | | formulation |
| | | | | no solubilizer |
| | | | | no foam |
| | | | | suppressant |
| | | Caustic soda | 12.80% | no defoamer |
| | | Biocide | 0.10% | |
| | | (Acticid MBS) | | |
| | | Water | 27.10% | |
| | | | 100.00% | |
| I | b | Phosphate I | 60.00% | problem-free |
| | | | | formulation |
| | | SagTex DSA | 0.50% | no solubilizer |
| | | Caustic soda | 12.80% | |
| | | Biocide | 0.10% | |
| | | (Acticid MBS) | | |
| | | Water | 26.60% | |
| | | | 100.00% | |
| I | c | Phosphate I | 60.00% | problem-free |
| | | | | formulation |
| | | | | no solubilizer |
| | | ZJ 834 | 3.00% | no defoamer |
| | | (isononanoamide) | | |
| | | Caustic soda | 12.80% | just foam |
| | | | | suppressant |
| | | | | (Si-free) |
| | | Biocide | 0.10% | |
| | | (Acticid MBS) | | |
| | | Water | 24.10% | |
| | | | 100.00% | |
| I | d | Phosphate I | 60.00% | problem-free |
| | | | | formulation |
| | | SagTex DSA | 0.20% | no solubilizer |
| | | ZJ 834 | 1.00% | |
| | | (isononanoamide) | | |
| | | Caustic soda | 12.80% | |
| | | Biocide | 0.10% | |
| | | (Acticid MBS) | | |
| | | Water | 25.90% | |
| | | | 100.00% | |
| II | a | Phosphate II | 60.00% | similar to Ib, |
| | | (24 h 115° C.) | | except for 24 h |
| | | SagTex DSA | 0.50% | phosphated at |
| | | | | 115° C. |
| | | | | slightly higher |
| | | | | viscosity |
| | | Caustic soda | 12.80% | otherwise the |
| | | | | same as Ib |
| | | Biocide | 0.10% | |
| | | (Acticid MBS) | | |
| | | Water | 26.60% | |
| | | | 100.00% | |
| III | a | Phosphate III | 60.00% | viscous liquid |
| | | SagTex DSA | 0.50% | |
| | | Caustic soda | 12.20% | |
| | | Biocide | 0.10% | |
| | | (Acticid MBS) | | |
| | | Water | 27.20% | |
| | | | 100.00% | |
| III | b | Phosphate III | 60.00% | viscous liquid |
| | | ZJ 834 | 3.00% | |
| | | (isononanoamide) | | |
| | | Caustic soda | 12.20% | |
| | | Biocide | 0.10% | |
| | | (Acticid MBS) | | |
| | | Water | 24.70% | |
| | | | 100.00% | |
| IV | a | Phosphate IV | 60.00% | colourless to |
| | | | | yellow liquid |
| | | SagTex DSA | 1.00% | may occasionally |
| | | | | also be pasty |
| | | | | depending on |
| | | | | phosphation |
| | | Caustic soda | 7.50% | increased |
| | | | | defoamer content |
| | | Biocide | 0.00% | |
| | | (Acticid MBS) | | |
| | | Water | 31.50% | |
| | | | 100.00% | |
| V | a | Phosphate V | 60.00% | colourless liquid |
| | | SagTex DSA | 1.00% | like IV, but an |
| | | | | additional 10% of |
| | | | | isodecanol |
| | | | | fraction in |
| | | | | phosphated |
| | | | | alcohol |
| | | Caustic soda | 7.50% | reduced alkali |
| | | | | stability |
| | | | | compared with |
| | | | | IV, hence not |
| | | | | tested any further |
| | | Biocide | 0.00% | |
| | | (Acticid MBS) | | |
| | | Water | 31.50% | |
| | | | 100.00% | |

COMPARATIVE FORMULATIONS

| | | | | |
|---|---|---|---|---|
| VI | a | Phosphate VI | 60.00% | brown paste |
| | | SagTex DSA | 0.50% | |
| | | Caustic soda | 12.20% | |
| | | Biocide | 0.10% | |
| | | (Acticid MBS) | | |
| | | Water | 27.20% | |
| | | | 100.00% | |
| VI | b | Phosphate VI | 60.00% | brown paste |
| | | ZJ 834 | 3.00% | |
| | | (isononanoamide) | | |
| | | Caustic soda | 12.20% | |
| | | Biocide | 0.10% | |
| | | (Acticid MBS) | | |
| | | Water | 24.70% | |
| | | | 100.00% | |
| VII | a | Phosphate VII | 60.00% | brown paste |
| | | SagTex DSA | 0.50% | |
| | | Caustic soda | 12.20% | |
| | | Biocide | 0.10% | |
| | | (Acticid MBS) | | |
| | | Water | 27.20% | |
| | | | 100.00% | |
| VII | b | Phosphate VII | 60.00% | brown paste |
| | | ZJ 834 | 3.00% | |
| | | (isononanoamide) | | |
| | | Caustic soda | 12.20% | |
| | | Biocide | 0.10% | |
| | | (Acticid MBS) | | |
| | | Water | 24.70% | |
| | | | 100.00% | |
| VIII | a | Phosphate VIII | 30.00% | brown paste |
| | | SagTex DSA | 0.25% | not stirrable as |
| | | | | 60% version and |
| | | | | hence not |
| | | | | formulatable |
| | | Caustic soda | 6.10% | half |
| | | | | concentration |
| | | Biocide | 0.05% | |
| | | (Acticid MBS) | | |
| | | Water | 63.60% | |
| | | | 100.00% | |
| VIII | b | Phosphate VIII | 30.00% | brown paste |
| | | | | not stirrable as |
| | | | | 60% version and |
| | | | | hence not |
| | | | | formulatable |
| | | ZJ 834 | 1.50% | |
| | | (isononanoamide) | | |
| | | Caustic soda | 6.10% | half |
| | | | | concentration |
| | | Biocide | 0.05% | |
| | | (Acticid MBS) | | |
| | | Water | 62.35% | |
| | | | 100.00% | |

TABLE 4
Applicatory results

| | | | | | Ross-Miles foam, | | Wetting, |
|---|---|---|---|---|---|---|---|
| Phos- | | | Viscos- | Alkali | alkaline (2° Bé) | | alkaline |
| phate | | | ity | stability | direct | 1 min still | 2 g/l |
| No. | Formulation* | Aspect | cPs | °Bé | ml | ml | s |
| Ia | | clear, colourless | 225 | 16 | 175 | 90 | 46 |
| Ib | | min. cloudy, | 225 | 16 | 0 | 0 | 42 |
| | | colourless | | | | | |
| Ic | | clear, colourless | 215 | 16 | 65 | 10 | 40 |
| Id | | min. cloudy, | 220 | 16 | 40 | 0 | 41 |
| | | colourless | | | | | |
| IIa | | moderately | 470 | 16 | 0 | 0 | 50 |
| | | viscous | | | | | |
| IIIa | | stable, viscous | 960 | >17 | 20 | 0 | 78 |
| IIIb | | stable, viscous | 800 | >17 | 60 | 10 | 78 |
| IVa | 1% of defoamer | stable, liquid | n.b. | 15 | 50 | 10 | 50 |
| Va | 1% of defoamer | stable, liquid | n.b. | 10 | n.b. | n.b. | n.b. |

COMPARATIVE TESTS

| | | | | | | | |
|---|---|---|---|---|---|---|---|
| VIa | | brown paste | 1700 | 17 | 10 | 0 | 85 |
| VIb | | brown paste | 1700 | 17 | 40 | 20 | 79 |
| VIIa | | brown paste | 1500 | 15 | 50 | 5 | 60 |
| VIIb | | brown paste | 1400 | 17 | 20 | 0 | 59 |
| VIIIa | 30% of AS, | brown paste | highly | >17 | 20 | 0 | ca. 200 |
| | twice the amount | | viscous | | | | |
| | applied | | | | | | |
| VIIIb | 30% of AS, | brown paste | highly | >17 | 80 | 50 | ca. 200 |
| | twice the amount | | viscous | | | | |
| | applied | | | | | | |

*unless explicitly mentioned, all formations contain 60% active and 0% solubilizer, and the cloud point is >80° C. for all (applicatory advantage)
n.b. not assessed;
AS active substance

The examples show distinctly that the present invention's formulations of the novel phosphoric esters of certain Guerbet alcohols have a very good property profile, i.e. high stability to alkali, minimal foaming and good wetting.

1. A compound of the formula (I) 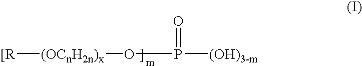
wherein
m is from 1 to 3,
n is 2 or 3,
x is from 6 to 8, and
R is a radical of the formula (II) 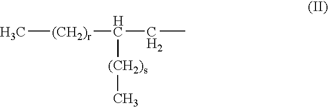
where
r is from 2 to 6,
s is from 0 to 4,
the sum total of (r+s) is from 5 to 7, and wherein
the alkyl chains are linear or branched.

2. A compound according to claim 1 wherein
m is from 1 to 2,
n is 2,
x is 7,
r is 4,
s is 2, and
the sum total of (r+s) is 6.

3. A process for preparing a compound of the formula (I) according to claim 1 comprising the steps of alkoxylating and subsequently phosphating a Guerbet alcohol of the formula R—OH, wherein R is a radical of the formula (II).

4. A process according to claim 3, wherein the Guerbet alcohol is a C₁₀-Guerbet alcohol and wherein the alkoxylating step further comprises reacting the C₁₀-Guerbet alcohol with ethylene oxide to form an alkoxylated C₁₀-Guerbet alcohol and the phosphating step further comprises reacting the alkoxylated C₁₀-Guerbet alcohol with phosphorus pentoxide.

5. A composition comprising at least one compound of the formula (I) according to claim 1 and water.

6. A composition according to claim 5 comprising 40% to 70% by weight of the at least one compound of the formula (I), with 2% to 4% by weight being present in the form of the sodium salt, and 0.1% to 3.5% by weight of at least one auxiliary, selected from the group consisting of surfactants, biocides, defoamers and foam suppressants.

7. A process for producing a composition according to claim 6, comprising the step of mixing at least one compound of the formula (I) and at least one auxiliary in an aqueous medium.

8. A process for pretreating a textile material comprising the step of pretreating a textile material with a compound of the formula (I) according to claim 1.

9. A process according to claim 8, wherein the pretreatment step comprises continuous or batch pretreatment operations under alkaline conditions.

10. A process for pretreating a textile material comprising the step of pretreating a textile material with a composition according to claim 5.

11. A textile material pretreated with a compound according to claim 1.

12. A textile material pretreated with a composition according to claim 5.

13. A pretreated textile material made in accordance with the process according to claim 8.

14. A pretreated textile material made in accordance with the process according to claim 9.
